(19) United States
(12) Patent Application Publication
(10) Pub. No.: US 2022/0315047 A1
(43) Pub. Date: Oct. 6, 2022

(54) METHOD, SYSTEM AND VEHICLE WITH AN UNCERTAINTY-BASED LANE POSITIONING CONTROL

(71) Applicant: Honda Research Institute Europe GmbH, Offenbach/Main (DE)

(72) Inventors: Malte Probst, Offenbach (DE); Thomas Weisswange, Offenbach (DE); Tim Puphal, Offenbach (DE); Raphael Wenzel, Offenbach (DE)

(73) Assignee: Honda Research Institute Europe GmbH, Offenbach/Main (DE)

(21) Appl. No.: 17/218,122

(22) Filed: Mar. 30, 2021

(51) Int. Cl. B60W 60/00; B60W 30/16; B60W 30/095; B60W 30/09; B60W 40/04

(52) U.S. Cl. CPC B60W 60/0011; B60W 60/00274; B60W 60/0015; B60W 30/16; B60W 30/0956; B60W 30/09; B60W 40/04; B60W 2554/4041; B60W 2554/801

(57) ABSTRACT

The present invention relates to a method for assisting a driver of an ego-vehicle in a traffic situation, wherein an ego-trajectory of the ego-vehicle and a trajectory of a traffic participant are calculated, an ego-trajectory alternative is generated by applying a lateral shift to the calculated ego-trajectory, an uncertainty area at least with respect to a lateral direction is determined for each trajectory, a spatio-temporal closeness of the uncertainty area of the ego-trajectory and the uncertainty area of the trajectory of the traffic participant is estimated for each of the plurality of ego-trajectories and an ego-trajectory is selected from the plurality of ego-trajectories based on the evaluated spatio-temporal closeness.

### TECHNICAL FIELD

The invention relates to a method and a system for assisting a driver in driving a vehicle; and a vehicle having mounted such system thereon. More specifically, the invention relates to a driver assistance system and method that actively control a vehicle or merely assist the driver to drive on a lane.

### BACKGROUND

During the last years driver assistance systems have been developed in order to increase the comfort for a driver and the safety of driving. Such driver assistance systems are capable of sensing the environment around a vehicle and providing information to the driver or performing autonomous or partially autonomous driving. In order to do so vehicles are equipped with sensors like radar and/or lidar sensors and/or with image processing systems that include a camera for recognizing objects in the environment of the vehicle.

Some systems for active lane keeping merely adjust steering control to always keep the vehicle in the center of the driving lane or within a small corridor around the lane center, but do not consider other vehicles or only predecessors.

Blind Spot Warning and Lane Change Assistants support the driver by handling situations with another vehicle on an adjacent lane, in particular for lane change intentions, by warning about risk of a lane change maneuver towards such a blocked lane.

In some systems for autonomous driving, behavior of other traffic participants relevant for the correct determination of a traffic situation is estimated, wherein trajectories for the own vehicle (ego-vehicle) and another traffic participant are predicted and a relation between their trajectories is used to describe a risk of ego-vehicle for travelling further on its trajectory.

EP 2 950 294 A1 discloses a driver assistance system, in which a predicted trajectory for the ego-vehicle 1s varied to generate a plurality of ego-trajectory alternatives, a critical event risk map is generated based on the ego-trajectory alternatives and a predicted trajectory of another vehicle and a path for the ego-vehicle having low risk and high efficiency is estimated based on the critical event risk map.

The above described driver assistance systems have the disadvantage that they do not consider changing uncertainties in the future time of estimated trajectories, e.g., in the position of the vehicle. However, taking strong safety measures based on such uncertain information is not advisable. In particular, vehicles in neighboring lanes can cause potential danger, both for lateral and longitudinal collisions, when moving laterally towards the ego vehicle's (future) path. Such motions are difficult to predict with high spatial accuracy. In addition, many sensors provide noisy signals with respect to the detected lateral position, lateral velocity and lateral acceleration of other vehicles and the ego vehicle. The detection accuracy also depends on the vehicle size, wherein smaller vehicles, such as motorbikes or cars are detected less accurate (larger parametrized positional uncertainty) than larger vehicles, e.g. buses or trucks (smaller positional uncertainty). Further, smaller vehicles are more likely to change the lateral position more often than larger vehicles so that the growth of uncertainty is also larger, as well as in the absence of lane markings.

It is desired to overcome the above-mentioned drawbacks and to provide an improved method for assisting a driver in driving a vehicle. More specifically, it is desired to provide a method for assisting a driver of an ego-vehicle in a traffic situation, a driver assistance system and a vehicle comprising such driver assistance system, with which collision risk can be reduced with low effort and costs and which produce useful and comfortable ego-trajectories. This is achieved by a method, a system and a vehicle according to the enclosed independent claims.

### SUMMARY

The present disclosure provides a method and a system for assisting a driver in driving a vehicle and a vehicle having mounted such system thereon.

The method for assisting a driver of an ego-vehicle in a traffic situation comprises the steps of selecting at least one traffic participant involved in the traffic situation, calculating a trajectory of the at least one traffic participant, calculating an ego-trajectory of the ego-vehicle, generating at least one ego-trajectory alternative by applying a lateral shift to the calculated ego-trajectory to generate a plurality of ego-trajectories including the calculated ego-trajectory and the at least one ego-trajectory alternative, selecting, for each trajectory of the plurality of ego-trajectories and the trajectory of the at least one traffic participant, a position on the trajectory that corresponds to a common point in time, determining, for each selected position, an uncertainty area at least with respect to a lateral direction, evaluating, for each of the plurality of ego-trajectories, at least a spatio-temporal closeness of the uncertainty area of the respective ego-trajectory and the uncertainty area of the trajectory of the at least one traffic participant, and selecting an ego-trajectory from the plurality of ego-trajectories based on the evaluated spatio-temporal closeness.

The driver assistance system according to the disclosure is configured to carry out the method and the vehicle 1s equipped with the driver assistance system or is connected to the driver assistance system using a radio connection to receive information on the selected ego-trajectory or to receive information for controlling the vehicle and/or guiding the driver to drive in accordance with the selected ego-trajectory.

The system and/or any of the functions described herein may be implemented using individual hardware circuitry, using software functioning in conjunction with at least one of a programmed microprocessor, a general purpose computer, using an application specific integrated circuit (ASIC) and using one or more digital signal processors (DSPs).

### BRIEF DESCRIPTION OF THE DRAWINGS

FIG. 1a to FIG. 1c illustrate uncertainties of estimated vehicle positions,

FIG. 2 shows a flowchart of the method according to an embodiment of the present disclosure;

FIG. 3 to FIG. 20 illustrate traffic situations and the steps carried out by the driver assistance system; and

FIG. 21 shows a schematic of the system according to an embodiment of the present disclosure.

### DETAILED DESCRIPTION

With the method and system for assisting a driver of an ego-vehicle in a traffic situation according to the disclosure, at least one traffic participant involved in the traffic situation is selected and a future trajectory of the at least one traffic participant and a future ego-trajectory of the ego-vehicle are calculated. At least one future ego-trajectory alternative is generated by applying a lateral shift to the calculated ego-trajectory to generate a plurality of ego-trajectories including the calculated ego-trajectory and the at least one ego-trajectory alternative. A position on each trajectory of the plurality of ego-trajectories and the trajectory of the at least one traffic participant the trajectory that correspond to a common point in time is selected. For each selected position, an uncertainty is estimated and an uncertainty area (offset) at least with respect to a lateral direction of the trajectory is determined based on the estimated uncertainty.

Information on the closeness of uncertainty areas is used to evaluate a potential risk of an ego-trajectory, wherein overlapping areas represent a high risk. Therefore, at least spatio-temporal closeness of the uncertainty area of the respective ego-trajectory and the uncertainty area of the trajectory of the at least one traffic participant is evaluated for each of the plurality of ego-trajectories and an ego-trajectory is selected from the plurality of ego-trajectories based on the evaluated spatio-temporal closeness.

In the simplest case, the uncertainty area is an offset of the selected position in lateral direction and the distance between the offsets is determined to evaluate a potential risk of an ego-trajectory.

With the uncertainty areas (offsets), position uncertainties are modeled, wherein the uncertainty models allow to incorporate continuous inaccuracies of signals (e.g., inaccuracies of sensors or prediction models) into the lane positioning of an assistance system. For small lateral offsets, this is a crucial functionality for such a system. Since a lateral offset reduces spatio-temporal event criticality, the future lateral distance between the ego-vehicle and other vehicles can be increased in accordance with the evaluated potential risk. This not only increases distance/Time-To-Collision for lateral events but also increases the time to react (i.e. missing vehicle in blind spot at overtaking), allows quicker and smaller evasion maneuvers for critical longitudinal following events and increases the time-to-overlap (i.e. when the situation becomes a longitudinal event) for cut-in cases in front (increased braking time, lower required braking force and allows quicker and smaller evasion maneuvers).

In order to assist the driver, a signal or information guiding the driver of the ego-vehicle to drive in accordance with the selected ego-trajectory can be generated. The information or the signal output to the driver can indicate instructions to adapt at least one of vehicle steering and velocity. A human-machine-interface may be configured to provide visual output, in particular using at least one of a display unit, audio output (e.g. using loudspeakers) and tactile output (e.g. using vibration elements, such as vibration elements positioned at the steering wheel).

Alternatively or in addition, in the case of autonomous or partially autonomous driving, the ego-vehicle can be controlled to drive in accordance with the selected ego-trajectory by generating driving control signals controlling at least one of acceleration, braking and steering of the ego-vehicle.

The uncertainty area is one-dimensional, two-dimensional or three-dimensional and can be a calculated probability distribution centered on a selected position estimate of the common point in time. In this way, uncertainties are modeled so that they may change over future time within the same prediction.

The uncertainty area can be determined by estimating at least one of inaccuracies of sensors sensing the traffic situation, inaccuracies in detecting the traffic situation based on the sensor signals, inaccuracies in calculating the ego-trajectory, inaccuracies in calculating the trajectory of the at least one traffic participant and inaccuracies in generating the at least one ego-trajectory alternative.

The inaccuracies in detecting the traffic situation can include inaccuracy in determining at least one of position of the ego-vehicle, velocity of the ego-vehicle, position of the at least one traffic participant, velocity of the at least one traffic participant, a size of the at least one traffic participant, type of the at least one traffic participant and position of lane markings.

The inaccuracies in calculating the trajectory of the at least one traffic participant can include at least one of uncertainty in distinction between dynamic and static objects in a lane of the at least one traffic participant, uncertainty in future behavior of the at least one traffic participant passing the static object, uncertainty in behavior predicting for the at least one traffic participant due to inconsistent behavior in the past, uncertainty in predicting positions of the at least one traffic participant due to no lane markings, uncertainty in predicting positions of the at least one traffic participant due to positions of the at least one traffic participant that oscillate around the lane centerline in the past and any further information which help to dynamically change and parametrize the uncertainty model.

The ego-trajectory can be selected in order to reduce lateral distance between the selected position of the selected ego-trajectory and the selected position of the calculated ego-trajectory and to increase distance between the uncertainty areas. Alternatively, the ego-trajectory can be selected in order to reduce lateral distance between the selected position of the selected ego-trajectory and the center of the lane and to increase distance between the uncertainty areas, when the calculated ego-trajectory is not in line with the center of the lane.

The calculated ego-trajectory can include a velocity profile, wherein the method further comprises changing the velocity profile in the calculated ego-trajectory to generate another ego-trajectory alternative, and/or changing the velocity profile in the ego-trajectory alternative shifted by the at least one lateral shift to generate a plurality of ego-trajectory alternatives including the ego-trajectory in which the velocity profile is changed.

When the ego-vehicle drives on a lane, a maximum of the lateral shift can be set so that the ego-vehicle drives just inside markings of the lane.

A plurality of ego-trajectory alternatives can be generated by applying a plurality of different lateral shifts to the calculated ego-trajectory.

In addition, when a first traffic participant on an adjacent lane of the ego-vehicle and a second traffic participant on the other adjacent lane of the ego-vehicle are selected in the traffic situation, the plurality of ego-trajectory alternatives can be generated so that the calculated ego-trajectory is between two ego-trajectory alternatives.

The ego-trajectory can be selected so that distance between the uncertainty area of the respective ego-trajectory and the uncertainty area of the trajectory of the first traffic participant and distance between the uncertainty area of the respective ego-trajectory and the uncertainty area of the trajectory of the second traffic participant are not shorter than a minimum distance. In addition, when the first traffic participant and/or the second traffic participant is a vehicle, the vehicle size can be included in the risk estimation.

Alternatively or in addition, for each trajectory of the plurality of ego-trajectories and the trajectory of the at least one traffic participant, a plurality of positions on the trajectory can be selected, wherein the ego-trajectory is selected from the plurality of ego-trajectories based on the evaluated spatio-temporal closeness of a plurality of the uncertainty areas of the respective ego-trajectory and a plurality of the respective uncertainty areas of the trajectory of the at least one traffic participant.

The driver assistance system according to the disclosure comprises a processing unit configured to carry out the steps described above. The processing unit can be a controller, a microcontroller, a processor, a microprocessor, an application specific integrated circuit (ASIC), a field-programmable gate-array (FPGA) or any combination thereof.

In the figures, same reference numbers denote same or equivalent structures. The explanation of structures with same reference numbers in different figures is avoided where deemed possible for sake of conciseness.

In order to evaluate a traffic situation, it is important to accurately determine the position of, for example, the ego-vehicle, other vehicles and lane markings absolute in a map or relative to the ego-vehicle. However, the determination of position, velocity and acceleration by sensors naturally is afflicted with an error. This leads to inaccuracies (error margin), which can be indicated by the manufacturer or determined by experiments. In addition to the determined current position, inaccuracies also occur in the subsequent steps for predicting the vehicle position/trajectory.

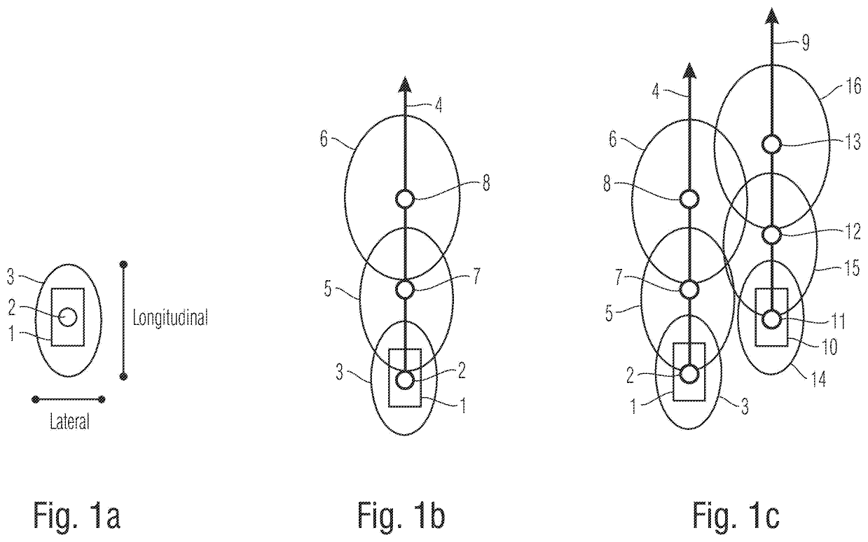

FIG. 1a to FIG. 1c illustrate uncertainties of estimated vehicle positions, wherein FIG. 1a shows the ego-vehicle 1 at a position 2 and an uncertainty area 3 of the vehicle position 2. The uncertainty area 3 is two-dimensional and represents the uncertainty in the longitudinal and lateral direction at a current time t1. FIG. 1b shows an ego-trajectory 4 and uncertainty areas 3, 5 and 6 at positions 2, 7 and 8, respectively, wherein position 2 corresponds to the current time t1 and positions 7 and 8 correspond to future times t2 and t3 along the trajectory 4, respectively. As shown in FIG. 1B, the uncertainties grow over the future times from t1 to t2 and t2 to t3 along the trajectories.

FIG. 1c shows the ego-trajectory 4 and a trajectory 9 of another vehicle 10 driving in parallel to the ego-vehicle 1. For estimating collision risk, positions 11, 12 and 13 on the trajectory 9 corresponding to the times t1, t2 and t3 and, thus, positions 2, 7 and 8 of trajectory 4 are selected, an uncertainty area 14, 15 and 16 is determined for each position 11, 12 and 13 and the closeness of uncertainty areas 3 and 14, the closeness of uncertainty areas 5 and 15 and closeness of the uncertainty areas 6 and 16 are estimated, wherein the overlapping areas 5 and 15 and the overlapping areas 6 and 16 represent a high collision risk. Since, in the illustrated example, the risk increases with the time, the velocity of the ego-vehicle 1 can be reduced and/or the lateral distance to the trajectory 9 can be increased in order to reduce the risk at the times t2 and t3. Generally, the risk is estimated the higher the close of the uncertainty areas are or the greater the overlap of uncertainty areas is. Further, in the illustrated example, the risk increases over time. However, depending on the respective future trajectories 4 and 9, it might also be the case that the risk decreases over time.

Uncertainty can describe the spread of possibilities or probabilities of positions (absolute in map or relative to the ego vehicle) of scene elements (vehicle, lane markings, . . . ) at certain times around an assumed, measured or derived value (“Position Estimate”) that is communicated to a module. This is applicable also to other types of assumed, measured or derived attributes of environment elements, e.g. velocity, acceleration, size, etc.

The uncertainty is typically modelled through a 1D-, 2D- or even 3D probability distribution (e.g. Gaussian distribution) centered on the Position Estimate of a certain time step. Uncertainty in this framework is relative to the variance of such a distribution and usually implies a lower probability for the Position Estimate to be the true position and increasing probabilities for larger deviation of the true position from the Position Estimate.

The parameters of the probability distribution can be defined as a function of position or time, i.e. for any point on a continuous or discrete spatio-temporal trajectory of a scene element, the uncertainty can be determined.

Uncertainty is a means to explicitly incorporate known and/or unknown sources of inaccuracies for modules that work with the position of scene elements.

The amount of uncertainty of a specific data point at the current time (from a specific sensor/perception module or actuator module) can be determined or defined based on known physical (sensor/actuator) effects, prior knowledge (e.g. from controlled experiments, historical statistics/expert knowledge) and/or can be taken from the direct output of machine learning methods (e.g. as “detection confidence”) or signal processing methods (such as a Kalman filter for object tracking).

Such uncertainty can vary with sensor origin, position relative to the ego-vehicle 1 or its sensors (e.g. radial, distance, front vs back), type of scene element, overall scene (possible occludes, reflecting surfaces, etc), ego or other's velocity, weather/road/lighting conditions, actuator mechanisms.

When predicting future positions of scene elements, the uncertainty of the position of an element at the current time can additionally be modified by the accuracy of the prediction method (which could also be a static function as in directly using the closest map path; and which in itself could depend on factors from the previous point, such as weather, element type, . . . ), and/or the estimated probability of a specific future trajectory leading to the future positions, and/or a factor that increases with temporal distance to the current time, and/or a factor that is based on the type of object, and/or based on the variance of the history of estimated positions of a specific element, and/or a factor that depends on current state of the element (velocity, yaw rate, acceleration, etc.).

These factors can differ between longitudinal and lateral uncertainties in the case of using 2D distributions as shown in FIG. 1a.

Alternatively, the prediction module itself could explicitly provide varying uncertainties, if the module uses machine-learning methods.

The set of uncertainties for each predicted time step depict the fact of growing uncertainties for times future ahead.

Some examples for the described uncertainty modeling may be:

1. The sensor type and size of a vehicle. While smaller vehicles, such as motorbikes or cars are detected less accurate (larger parametrized positional uncertainty), larger vehicles, e.g. buses or trucks, will be detected easier (smaller positional uncertainty). Further, smaller vehicles are more likely to change the lateral position more often than larger vehicles and the growth of uncertainty is larger as well.
2. The history of the driving is accounted in the positional uncertainty modeling. If another vehicle 1s oscillating around the lane centerline in the last seconds of the detection, the uncertainty (current and future time) is modeled to be higher.
3. The type of driving situation also changes the positional uncertainty level. At tollgates, vehicles make more lateral changes when there are no lane markings available. The positional uncertainty for future times is higher in such an area. This question can be generalized: are fixed lanes from maps given in the driving situation? If no such fixed lanes can be determined, the uncertainty level must be increased.
4. The density of vehicles on a lane also influences the driving behavior and will therefore result in more or less lateral movements. When lanes are occupied more densely, vehicles will more likely make a lane change or slightly change the intra-lane position than with less vehicles. The positional uncertainty along the respective estimated future trajectory is higher.

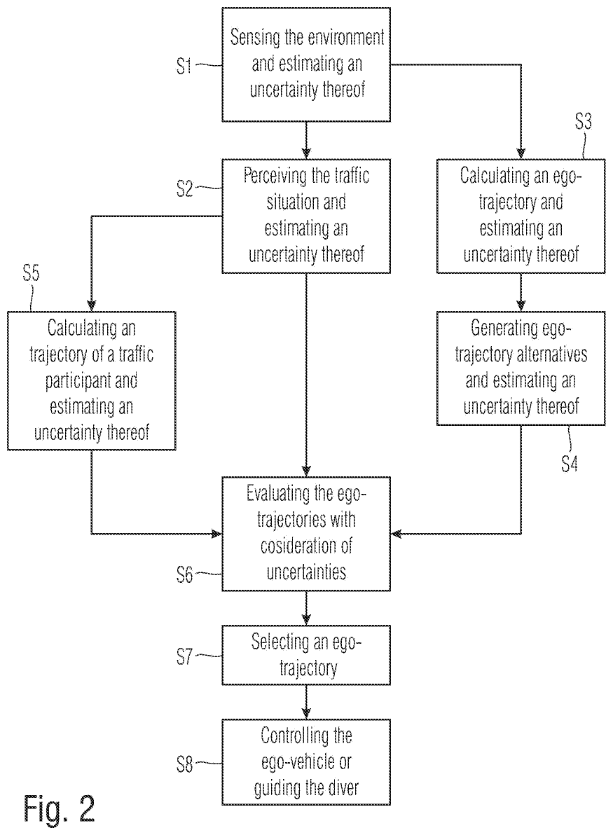

FIG. 2 shows a simplified flowchart of an embodiment of the method according to the present invention, wherein at least the steps S2 to S7 are carried out by the driver assistance system. In step S1, the environment around ego-vehicle 1 is sensed by sensors of the ego-vehicle 1 (e.g. camera, LIDAR, RADAR, GNSS) sensing the environment around the ego-vehicle 1 to generate environment information. Further, internal vehicle sensors or interior sensors (driver monitoring camera, eye/head tracking device) can sense the driver of the ego-vehicle 1. The uncertainty of at least the environment information is estimated based on, for example, sensor type and sensing condition (temperature, sight, detection angle, sensor range, velocity of the ego-vehicle 1, etc.). Alternatively or in addition, information on the environment can be obtained by Car2Car/Car2Infrastructure communication. When the system is not a part of the ego-vehicle 1, the information is transmitted from the ego-vehicle 1 to the system.

In step S2, perception modules of the system receive the environment information with an attached estimated uncertainty, provide semantic information about the environment of the ego-vehicle 1 (e.g. detection and tracking of vehicles, lane markings, and extraction of map paths at the current position) and estimate the uncertainty in generating the semantic information.

In step S3, the future ego-trajectory 4 is determined based on predefined map positions, a current or previous trajectory planning step of an automated system, an extrapolation of the past vehicle trajectory and/or based on a module that estimates such trajectory from current and previous actions of a human driver (including steering maneuvers, gas/brake pedal usage, gaze patterns, etc.). The ego-trajectory 4 consists of lateral and longitudinal positions over time or similar spatio-temporal parameters such as velocity-/acceleration profile over time and steering-/curvature-/lane offset over time. The prediction can cover a fixed constant future time, or, alternatively, the duration can be adjusted based on driving conditions like weather, ego velocity, current maneuver (e.g. lane change, vehicle following), autonomy state of vehicle (e.g. full driver controlled, lateral control—LKAS/longitudinal control—ACC only, fully automated, etc.), traffic amount or uncertainty of its prediction. Further, spatio-temporal uncertainty of the ego-trajectory is estimated based on, for example, ego position sensor or lane detection uncertainty, ego-trajectory prediction method, history of human driving inputs or ego-vehicle positions, prediction distance from current time, accuracy of vehicle control in following a target trajectory, etc.

In step S4, at least one ego-trajectory alternative is generated by applying a lateral shift to the ego-trajectory 4 predicted in step S4. One possibility for the system to generate alternative lateral shifts for the ego-trajectory 4 is to move the original predicted ego-trajectory 4 laterally (i.e. in orthogonal direction to the lane center) by a number of fixed values or values that are fractions of the overall lane width. Alternatively the shifts can be generated by moving the shape of the lane center line laterally (i.e. in orthogonal direction to the lane center) by a number of predefined values or values that are fractions of the overall lane width.

The ego-trajectory alternative will additionally include a part that connects the current position with the laterally shifted part in a smooth and controllable way considering the current velocity, lateral position and steering wheel angle. This part can be computed by fitting a parametric function between the current lane position and the laterally shifted part at a certain time in the future, where this time could depend e.g. on the current velocity or a predefined mapping between times and lateral distance to the current ego position. Any new created trajectory, with which the ego-vehicle 1 would violate the lane boundaries, will not be considered when no lane change is predicted.

In case the current or projected ego-trajectory 4 involves a lane change, the lateral shift candidates could also be generated by only shifting the lateral target position (and subsequent lane following part of the trajectory) in the target lane and adjusting the steering profile of the maneuvers during the lane change accordingly.

The spatio-temporal uncertainty of the ego-trajectory alternative is estimated by, for example, copying the uncertainties of the predicted ego-trajectory, computing uncertainties using similar parameters as described for ego-trajectory prediction, adapting the ego-trajectory prediction uncertainties to include additional factors scaling with e.g. curvature or distance to lane center/current position of the shifted trajectory.

In step S5, future trajectories 9 of other vehicles 10 are predicted using a ballistic, model-based or combined extrapolation of the past vehicle trajectory and/or the prediction of lane changing/keeping behavior using features such as blinker activation, or scene context as described in U.S. Ser. No. 10/625,776 B2 combined with a parametrically defined spatio-temporal profile. In addition, multiple alternative trajectories can be predicted, each assigned a probability of realization.

The trajectory 9 predicted in step S4 consists of lateral and longitudinal positions over time or similar spatio-temporal parameters such as velocity-/acceleration profile over time and steering-/curvature-/lane offset over time or alternatively consists of a spatio-temporal probability distribution for the positions of the vehicle. Further, spatio-temporal uncertainty of the trajectory is estimated based on, for example, position estimation uncertainty, trajectory prediction method, object type, history of vehicle positions/behaviors, prediction distance from current time, etc.

The prediction will usually be restricted to relevant vehicles in the vicinity of the ego vehicle 1. This might include vehicles on next left, next right and current ego lane and both in front of, next to and behind the ego vehicle 1 within a certain maximum distance or time-related measure (e.g. Time-To-Collision). In case of an active or predicted ego lane change, this might additionally consider vehicles on the lane next to the target lane of the ego vehicle 1.

The predicted trajectory 9 can cover a fixed constant future time or alternatively the duration can be set based on driving conditions (weather, ego velocity, current ego maneuver or maneuver of the other vehicle, e.g. lane change, vehicle following), autonomy state of ego-vehicle 1 (e.g. full driver controlled, lateral control/longitudinal control only, fully automated, etc.), traffic amount or uncertainty/probability of other's prediction or perception quality (e.g. range, occlusions, detection of a predecessor of the other vehicle, sensor noise level, available sensors, etc.).

In step S6, each of the original predicted ego-trajectory 4 and the ego-trajectory alternative(s) is evaluated with respect to safety as described above (see FIG. 1c) or also with respect to comfort and utility, wherein the system assigns each ego-trajectory a cost value that quantifies the quality with respect to comfort, safety and utility of the respective trajectory if driven by the ego-vehicle 1 in the current situation. The modeled positional uncertainties for the combination of the original predicted ego-trajectory 4 and the ego-trajectory alternative(s) can be used as an input for each cost part.

A first part of the cost value scales with the distance to the center line of the current lane, e.g. mean/max/min/sum of distances across the whole directory or distance at a given point in the trajectory (e.g. after 2S, 5S, 10S).

The second part of the cost is computed based on collision risk with other vehicles. This collision risk can be computed by multiplying and integrating the positional uncertainties for the trajectory of the ego-vehicle 1 and the other vehicle 10 at a certain time (e.g. t1, t2 or t3) and taking the mean, max, min or sum of the integral across all points along the trajectory. For a 1D Gaussian distribution of the ego-vehicle 1 and the other vehicle 10, this results in, e.g., two distributions N1(x(t+s)), N2(x(t+s)), which are depending on the position x from the current time t (e.g., t=t1) until the predicted time s (e.g., s={t2, t3}). The risk value R(t) for the current time t is a function of the two distributions: R(t)=f(N1(x(t+s)), N2(x(t+s)).

The shape of the cars can be considered in the risk model by increasing the risk value R(t) to, e.g., the maximal value, if not only the uncertainties 3, 5, 6 and 14, 15, 16 are overlapping but also the bodies of the ego-vehicle 1 and the other vehicle 10 are overlapping.

In the second part, lateral distances to vehicles that are not predicted to cut in can be accounted for, i.e. the predicted trajectory is constant with respect to lane position. In this case, the uncertainty of the other vehicle 10 protrudes into the lane of the ego vehicle and generates collision risk.

The system can be used with other deterministic methods as well such as taking the distance to the other vehicle 10 at a certain time t1, t2 or t3 (i.e. respective point on each trajectory), using Time-To-Collision or required braking force to prevent a collision (or surpass a defined minimal headway) at first trajectory overlap.

A third part of the cost can be used which scales with the comfort implications of the required driving maneuvers in the future. This preferably takes into account measures related to lateral acceleration (e.g. trajectory curvature, required steering wheel angle/velocity in relation to longitudinal velocity). Additionally, costs can be increased/reduced based on the history of selection of certain shifts to e.g. have lower cost when keeping the shift that was selected in the last iteration (this cost reduction could reduce the longer a certain shift is constantly selected).

In step S6, the trajectory evaluation is done for the entire trajectory or separately for spatio-temporal segments of the trajectory so that, for example, the cost for each segment of n seconds is computed separately which would allow to select a “mixed” trajectory in step S7.

All the cost parts (comfort, safety and utility) are weighted using a function depending on the trajectories' uncertainties, or simply using a function depending on the deterministic distance. Hereby, the scaling of the cost can be linear, polynomial or exponential.

Predictions for a time point far in the future time can be weighted less than predictions in close time. This is reflected by, for example, the growing uncertainties in the trajectories. Additionally, the discrete prediction probability for the ego-trajectory 4 and the trajectory 9 can be weighted likewise.

In step S7, trajectory with the lowest cost is selected from the entirety of predicted ego-trajectories including the original predicted ego-trajectory 4 and the ego-trajectory alternative(s). Alternatively, the best lateral shift for each of the predetermined temporal segments is selected as described above, wherein switching between successive segments forming the “mixed” trajectory is done using a smooth connecting function.

Additionally, the system can use a temporal filter function that stores the trajectory shifts with lowest cost from the past iterations and selects the shift that was selected most often; selects the current lowest cost shift only if it was lowest cost for the past n time steps (or in m of the last n time steps); or selects the current lowest cost shift only if it is at least better than the shift that was selected in the previous time step and otherwise selects the latter.

Additionally, the system can have a predefined cost threshold and if the selected trajectory shift has higher cost, the system will disengage (informing the driver) or keep the previously selected shift.

The system can perform trajectory shift selection with a constant update frequency or triggered by new data input. The (temporal) length of the selected trajectory, which is used for controlling the ego-vehicle 1, is preferably larger or equal the inverse of the minimum update frequency.

In step S8, vehicle steering and velocity is controlled to let the vehicle follow the selected trajectory. Alternatively or additionally, the selected trajectory shift can be communicated to the driver via a human-machine-interface to be used as information on or recommendation for a steering maneuver. In addition, the system can detect inaccuracies in the execution of the selected trajectory so that the inaccuracies can be modeled as uncertainties for the ego-trajectory prediction.

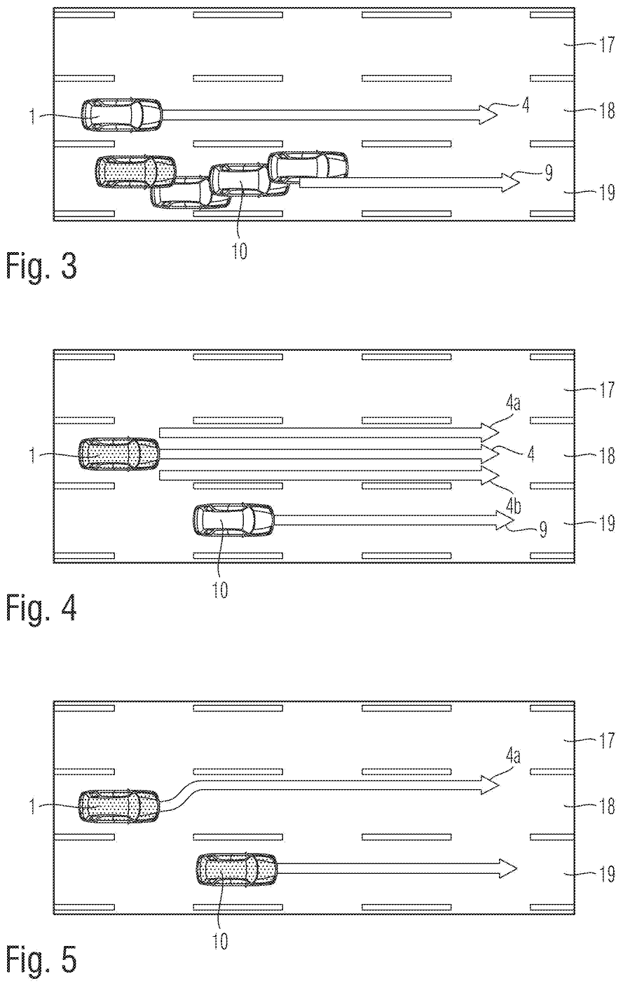

FIG. 3 to FIG. 8 illustrate a first traffic situation and the steps carried out by the driver assistance system. In FIG. 3, the ego-vehicle 1 and the other vehicle 10 drive on a three-lane highway 17, 18, 19 in the same direction, wherein the ego-vehicle 1 is driving in the middle lane 18 and the vehicle 10 is driving in the right lane 19. As indicated by the ego-trajectory 4 and the trajectory 9, the ego vehicle 1 is predicted to follow the lane center and the vehicle 10 is predicted to further drive on its own lane. However, the vehicle 10 has high uncertainty of its position, because it was swerving around in its own lane before.

As shown in FIG. 4, the system generates two ego-trajectory alternatives 4a, 4b by shifting the predicted ego-trajectory 4 by 0.5 m and −0.5 m orthogonal to the lane center to evaluate the predicted ego-trajectory 4 and the ego-trajectory alternatives 4a, 4b according to their costs. The costs are a combination of at least the collision risk with the vehicle 10 and the distance of the ego vehicle 1 to the lane center, wherein the costs increase with a high risk and with a decreased distance, i.e. the ego vehicle 1 is driving on the ego-trajectory alternative 4a or 4b.

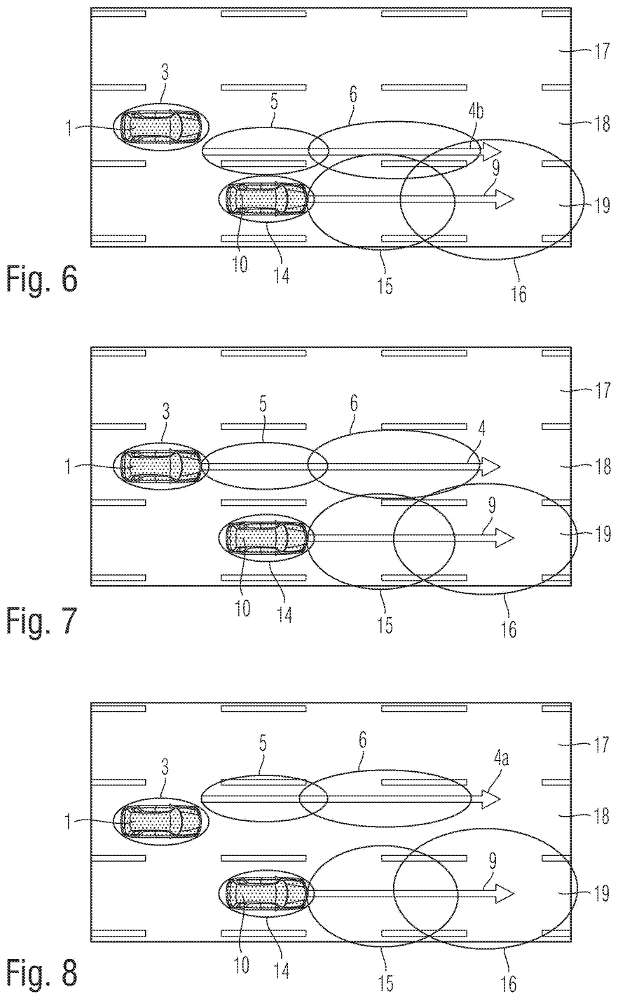

The evaluation is done with uncertainties of the estimated vehicle positions as shown in FIG. 6 to FIG. 8. Since the uncertainty of the position of the vehicle 10 is high and increases over the future time, the positional uncertainty (uncertainty areas 15 and 16) outreaches on the lane 18 of the ego-vehicle 1 and induces risk, especially in future times. As shown in FIG. 6, the overlap of uncertainty areas 6 and 16 is the highest for the ego-trajectory alternative 4b. With the predicted ego-trajectory 4, there is a (small) overlap of uncertainty areas 6 and 16, whereas the ego-trajectory alternative 4a has no overlaps and the lowest risk.

As shown in FIG. 5, the system selects the ego-trajectory alternative 4a as it provides additional safety due to the vehicles' uncertainty and steers the ego-vehicle 1 onto this new target trajectory in a smooth and controllable way. On the other hand, if there is overlap of uncertainty areas (risk) with respect to a vehicle driving in lane 17, the ego-trajectory 4 might be most optimal (lowest cost).

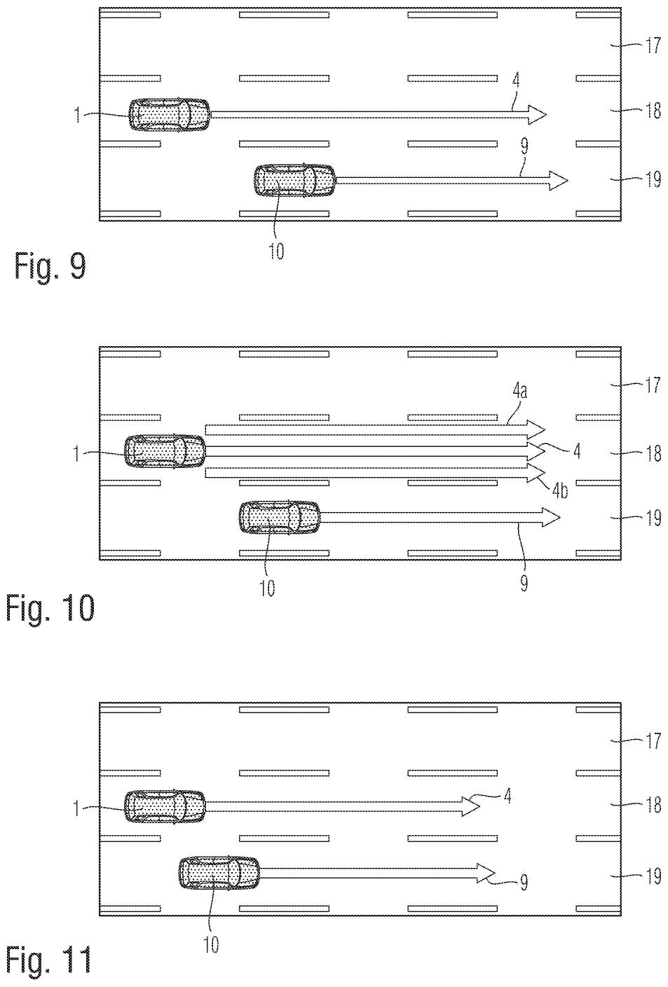

FIG. 9 to FIG. 14 illustrate a second traffic situation, in which, like in the first traffic situation, the ego-vehicle 1 and the vehicle 10 drive on the three-lane highway 17, 18, 19. However, the vehicle 10 was not swerving around in its own lane before and does not have high lateral uncertainty.

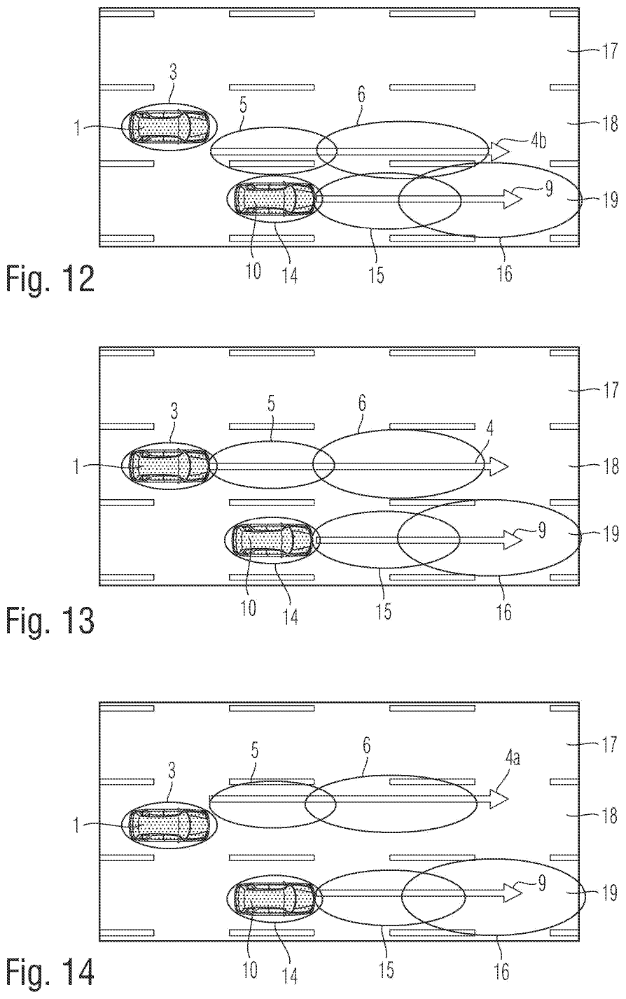

The system generates the ego-trajectory alternatives 4a and 4b by shifting the predicted ego-trajectory 4 by 0.5 m and −0.5 m orthogonal to the lane center as shown in FIG. 10 and evaluates the predicted ego-trajectory 4 and the ego-trajectory alternatives 4a, 4b according to their costs. As shown in FIG. 12, the lateral uncertainty of the vehicle 10 is low and the uncertainty areas 15 and 16 do not protrude into the lane 18 of the ego-vehicle 1.

Therefore, the ego-trajectory alternative 4a shown in FIG. 14 and the predicted ego-trajectory 4 shown in FIG. 13 have no over overlaps and thus have a low risk. Only for the ego-trajectory alternative 4a shown in FIG. 13 there is overlap of uncertainty areas 6 and 16. Choosing the predicted ego-trajectory 4 is most optimal (lowest cost), since the ego car is further staying on the lane centerline (no shift necessary) and the ego-trajectory alternative 4a does not reduce the risk much. Based thereon, the system selects the middle trajectory option as it provides safety and is on the lane center.

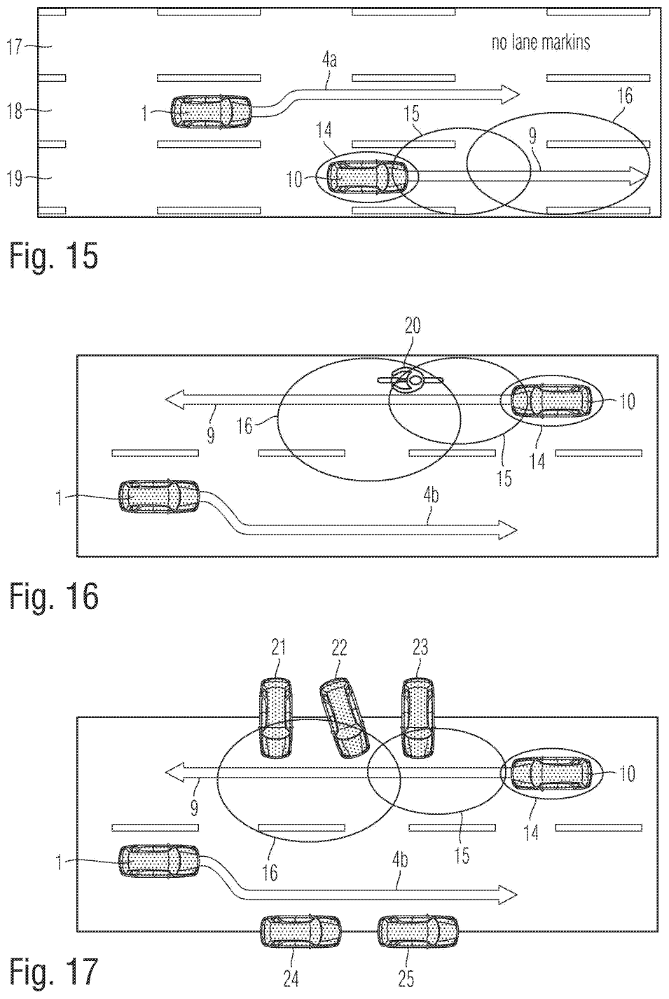

FIG. 15 illustrates a third traffic situation, in which the ego-vehicle 1 and the vehicle 10 drive on the three-lane highway towards an area of a tollgate that has no markings. In such unstructured environments, the uncertainties for other vehicles are generally higher and the ego-vehicle 1 should increase its lateral distance to the vehicle 10. Once the lanes 17, 18 and 19 are not marked, the lateral uncertainty of the vehicle 10 drastically increases and the system selects the ego-trajectory alternative 4a as it provides additional safety (uncertainty areas of ego-vehicle 1 are not shown).

FIG. 16 illustrates a fourth traffic situation, in which a bicycle 20 and the vehicle 10 drive towards the ego-vehicle 1 in an adjacent lane. The vehicle 10 is likely to overtake the bicycle 20 and will be on the lane of the ego-vehicle 1. The lateral uncertainty increases during the overtaking maneuver in the future time for the vehicle 10 and the system selects the ego-trajectory alternative 4b to allow the vehicle 10 to overtake. This is typically in inner-city scenarios, where instead of the bicycle 20, static object forces vehicles to drive in the middle of the road.

Another typical inner-city scenario is shown in FIG. 17, in which the oncoming vehicle 10 will pass parking lots. In parking lots, other vehicles 21 . . . 23 are likely to maneuver and change their lateral position to drive into parking spaces. Here, the uncertainty areas 15 and 16 are larger near the parking spaces and the system selects the ego-trajectory alternative 4b to allow the vehicle 10 to increase its distance to the parking lots and the vehicles 21 . . . 23. The system keeps higher distances to the dynamic vehicles (vehicle 10) than to the static, parked vehicles 24, 25.

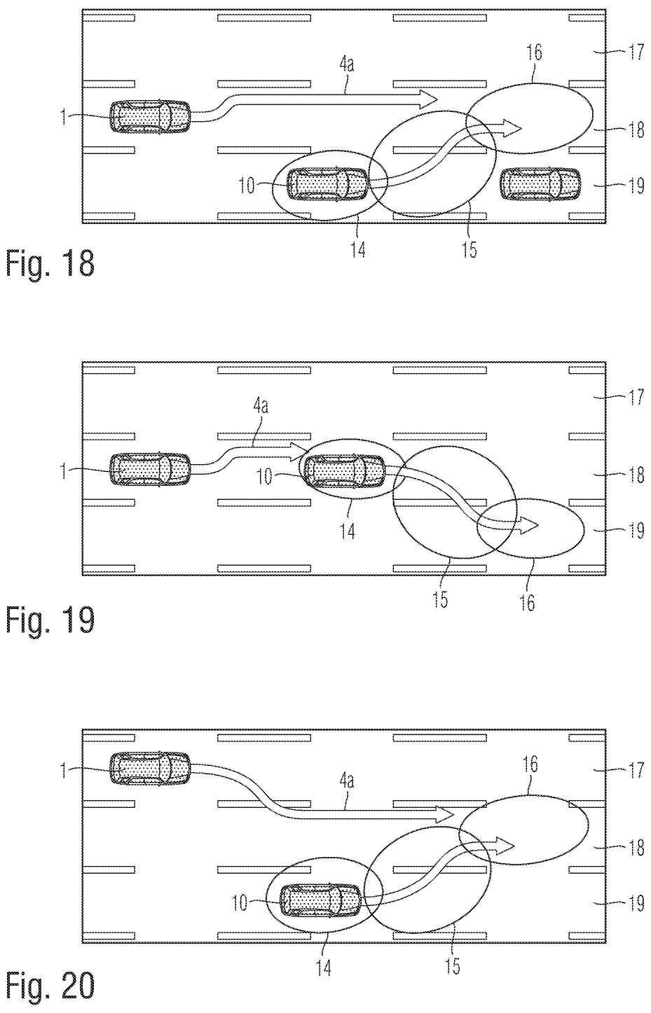

FIG. 18 to FIG. 20 illustrate different traffic situations, in which a lane change of the vehicle 10 is predicted. As shown in FIG. 18 to FIG. 20, the lateral uncertainty of the vehicle 10 is higher around the moment of crossing the lane markings, i.e., the uncertainty area 15 is larger than the uncertainty area 14 and the uncertainty area 16. This also applies to the ego-vehicle 1 if it changes the lane as shown in FIG. 20 (uncertainty areas of ego-vehicle 1 are not shown). The enlarged uncertainty area 15 reflects that the position at which the vehicle 10 crosses the lane cannot be determined exactly, whereas origin and target positions (uncertainty areas 14 and 16) are laterally defined by the origin lane and the target lane, respectively. In traffic situations shown in FIG. 18 to FIG. 20, the system selects the ego-trajectory alternative 4a as it provides additional safety.

The overlaps of uncertainties are reflected in the evaluation for the trajectory selection. This allows for lateral positioning with noisy sensor signals or situations with uncertain predictions beyond immediate future times. If the uncertainty is large, higher lateral distances will be taken to proactively increase safety.

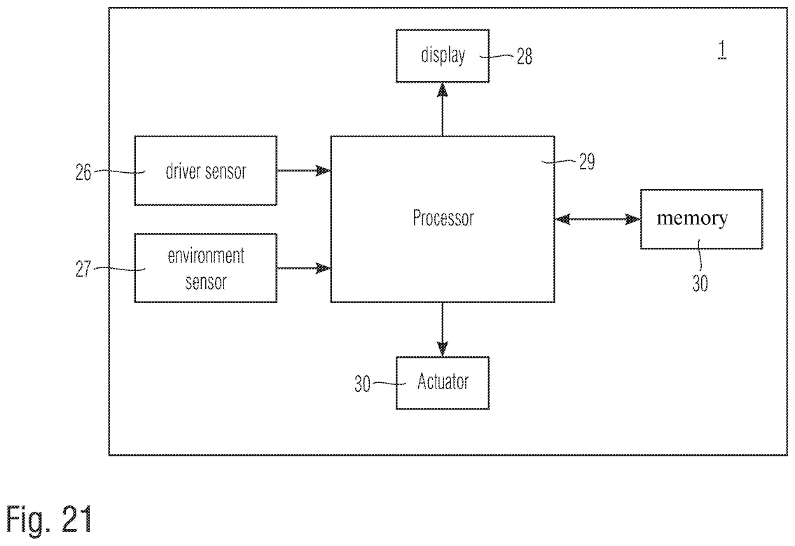

FIG. 21 shows a block diagram of the ego-vehicle 1. The ego-vehicle 1 comprises a plurality of environment sensors 26, 27 that allow to sense vehicles and other elements (e.g. lane markings) in the surrounding of the ego-vehicle 1. The environment sensors 26, 27 may comprise a camera, radar sensor and lidar sensor. The ego-vehicle 1 can further comprise a driver sensor used for monitoring the driver and/or a GPS system for identifying a current position of the ego-vehicle 1 (not shown).

The signals from the driver sensors 26 and the environment sensors 27 are supplied to a processor 29. In the processor 29, the steps S1 to S8 are carried out based on the input signals and on information stored in memory 30. Information stored in the memory 30 may be, for example, information for modeling the uncertainty as described above. The processor 29 outputs control signals to an actuator 30, with which the steering can be adjusted to reach the selected ego-trajectory.

Alternatively, the ego-trajectory can be determined/selected by an external system comprising the processor 29, the memory 30 and an interface for receiving signals at least from the environment sensors 27 and transmitting the control signals or the selected ego-trajectory to the ego-vehicle 1.

The ego-vehicle 1 comprises a display 28 to display information on the selected ego-trajectory or drive instructions to instruct the driver to drive in accordance with the selected ego-trajectory.

The ego-vehicle 1 can comprise a means for the driver to activate/deactivate the driver assistance system. The system preferably can only be activated within reasonable working conditions and automatically deactivates/prevents activation if required perception data cannot be provided (e.g. area with no map available if system uses map; lane detection not working properly)

The system can be combined with existing assistance function like adaptive cruise control.

It will be apparent to those skilled in the art that various modifications and variations can be made to the structure of the disclosure without departing from the scope or spirit of the disclosure. In view of the foregoing, it is intended that the preset disclosure covers modifications and variations of this disclosure provided they fall within the scope of the following claims and their equivalents.

What is claimed is:

1. A method for assisting a driver of an ego-vehicle in a traffic situation, comprising the steps of:
selecting at least one traffic participant involved in the traffic situation,
calculating a trajectory of the at least one traffic participant,
calculating an ego-trajectory of the ego-vehicle,
generating at least one ego-trajectory alternative by applying a lateral shift to the calculated ego-trajectory to generate a plurality of ego-trajectories including the calculated ego-trajectory and the at least one ego-trajectory alternative,
selecting, for each trajectory of the plurality of ego-trajectories and the trajectory of the at least one traffic participant, a position on the trajectory that corresponds to a common point in time,
determining, for each selected position, an uncertainty area at least with respect to a lateral direction,
evaluating, for each of the plurality of ego-trajectories, at least a spatio-temporal closeness of the uncertainty area of the respective ego-trajectory and the uncertainty area of the trajectory of the at least one traffic participant, and
selecting an ego-trajectory from the plurality of ego-trajectories based on the evaluated spatio-temporal closeness.

2. The method according to claim 1, further comprising at least one of the steps
generating, based on the selected ego-trajectory, driving control signals for controlling at least one of acceleration, braking and steering of the ego-vehicle, and
generating a signal or information guiding the driver of the ego-vehicle to drive in accordance with the selected ego-trajectory.

3. The method according to claim 2, wherein
the uncertainty area is one-dimensional, two-dimensional or three-dimensional, and
the uncertainty area is a calculated probability distribution centered on a selected position estimate of the common point in time.

4. The method according to claim 1, wherein
the uncertainty area is determined by estimating at least one of inaccuracies of sensors sensing the traffic situation, inaccuracies in detecting the traffic situation based on the sensor signals, inaccuracies in calculating the ego-trajectory, inaccuracies in calculating the trajectory of the at least one traffic participant and inaccuracies in generating the at least one ego-trajectory alternative.

5. The method according to claim 4, wherein
the inaccuracies in detecting the traffic situation include inaccuracy in determining at least one of position of the ego-vehicle, velocity of the ego-vehicle, position of the at least one traffic participant, velocity of the at least one traffic participant, a size of the at least one traffic participant, type of the at least one traffic participant and position of lane markings.

6. The method according to claim 4, wherein
the inaccuracies in calculating the trajectory of the at least one traffic participant include at least one of uncertainty in distinction between a dynamic object and a static object in a lane of the at least one traffic participant, uncertainty in future behavior of the at least one traffic participant passing the static object, uncertainty in behavior prediction for the at least one traffic participant due to inconsistent behavior in the past, uncertainty in predicting positions of the at least one traffic participant due to no lane markings and uncertainty in predicting positions of the at least one traffic participant due to positions of the at least one traffic participant that oscillated around the lane centerline in the past.

7. The method according to claim 1, wherein
the ego-trajectory is selected in order to reduce lateral distance between the selected position of the selected ego-trajectory and the selected position of the calculated ego-trajectory and to increase distance between the uncertainty areas, or
when the ego-vehicle drives on a lane, the ego-trajectory is selected in order to reduce lateral distance between the selected position of the selected ego-trajectory and the center of the lane and to increase distance between the uncertainty areas.

8. The method according to claim 1, wherein
the calculated ego-trajectory includes a velocity profile and the method further comprises at least one of the steps:
changing the velocity profile in the calculated ego-trajectory to generate another ego-trajectory alternative, and
changing the velocity profile in the ego-trajectory alternative shifted by the at least one lateral shift to generate a plurality of ego-trajectory alternatives including the ego-trajectory in which the velocity profile is changed.

9. The method according to claim 1, wherein
when the ego-vehicle drives on a lane, a maximum of the lateral shift is set so that the ego-vehicle drives just inside markings of the lane.

10. The method according to claim 1, wherein
a plurality of ego-trajectory alternatives is generated by applying a plurality of different lateral shifts to the calculated ego-trajectory.

11. The method according to claim 10, wherein
when a first traffic participant on an adjacent lane of the ego-vehicle and a second traffic participant on the other adjacent lane of the ego-vehicle are selected in the traffic situation, the plurality of ego-trajectory alternatives is generated so that the calculated ego-trajectory is between two ego-trajectory alternatives.

12. The method according to claim 11, wherein
the ego-trajectory is selected so that distance between the uncertainty area of the respective ego-trajectory and the uncertainty area of the trajectory of the first traffic participant and distance between the uncertainty area of the respective ego-trajectory and the uncertainty area of the trajectory of the second traffic participant are not shorter than a minimum distance.

13. The method according to claim 1, wherein
for each trajectory of the plurality of ego-trajectories and the trajectory of the at least one traffic participant, a plurality of the positions on the trajectory is selected, and
the ego-trajectory is selected from the plurality of ego-trajectories based on the evaluated spatio-temporal closeness of a plurality of the uncertainty areas of the respective ego-trajectory and a plurality of the respective uncertainty areas of the trajectory of the at least one traffic participant.

14. A driver assistance system configured to carry out the method according to claim 1.

15. A vehicle equipped with a driver assistance system according to claim 14.
